(19) United States
(12) Patent Application Publication
(10) Pub. No.: US 2019/0112095 A1
(43) Pub. Date: Apr. 18, 2019

(54) TWO IN ONE COMBINATION DISPLAY BOX

(71) Applicant: WestRock Shared Services, LLC, Atlanta, GA (US)

(72) Inventors: Jeremiah SWARNARAJ, Soledad, CA (US); David J. BRUNDAGE, Salinas, CA (US)

(21) Appl. No.: 16/217,891

(22) Filed: Dec. 12, 2018

Related U.S. Application Data
(63) Continuation-in-part of application No. 16/054,375, filed on Aug. 3, 2018.
(60) Provisional application No. 62/542,064, filed on Aug. 7, 2017.

(51) Int. Cl. B65D 5/54; B65D 5/42; B65D 5/00; B65D 5/36; B31B 50/20; B31B 50/26; B31B 50/62

(52) U.S. Cl. CPC B65D 5/5445; B65D 5/4266; B65D 5/005; B31B 2120/302; B31B 50/20; B31B 50/26; B31B 50/62; B65D 5/3621

(57) ABSTRACT

A container includes a tray portion configured for holding and displaying product. A cover portion is seated in the tray portion for forming an enclosure around product in the tray portion. The tray portion and the cover portion have the same length and breadth. An opening of the cover portion and/or an opening of the tray portion is slotted with open ended slots to allow at least a portion of the opening of the cover portion and/or a portion of the opening of the tray portion to be biased inward.

### CROSS-REFERENCE TO RELATED APPLICATIONS

This application is a continuation-in-part of U.S. patent application Ser. No. 16/054,375, filed on Aug. 3, 2018, which claims the benefit of priority under 35 U.S.C. § 119(e) to U.S. provisional application Ser. No. 62/542,064 filed on Aug. 7, 2017. Both applications are hereby incorporated by reference in their entirety.

### BACKGROUND OF THE INVENTION

### 1. Field of the Invention

The present disclosure relates to packaging, and more particularly to packaging for shipping and display.

### 2. Description of Related Art

A conventional 2-piece half slotted container (HSC) typically is packed where the product is produced. For example in the case of fresh produce, an HSC can be packed in the field where the produce is harvested and closed for shipping. HSC's can be shipped with product packed inside to a retail location. At the retail location the HSC is converted, e.g., by removing a separate lid from a tray bottom or the like, or by telescoping a two piece HSC, to display the product and make it accessible to customers. This conventional use of HSCs requires separate manufacture of the lid portion and the main portion of the HSC, but facilitates the ability of retailers and customers to handle the product.

The conventional techniques have been considered satisfactory for their intended purpose. However, there is an ever present need for improved HSCs. This disclosure provides a solution for this need.

### SUMMARY OF THE INVENTION

A container includes a tray portion configured for holding and displaying product. A cover portion is seated in the tray portion for forming an enclosure around product in the tray portion. The tray portion and the cover portion have the same length and breadth. An opening of the cover portion and/or an opening of the tray portion is slotted with open ended slots to allow at least a portion of the opening of the cover portion and/or a portion of the opening of the tray portion to be biased inward.

In accordance with some embodiments, the opening of the cover portion is seated in the tray portion and is slotted with open ended slots to allow the portion of the opening of the cover to be biased inward and for the portion of the opening of the cover to fit within and to be seated in the tray portion.

The tray portion can have a length dimension and a height dimension. The height dimension of the tray can vary along the length dimension of the tray. The open ended slots can be in corner edges of the cover portion. The cover portion can include breathability apertures completely defined through one or more walls thereof in addition to the open ended slots. The tray portion can define an opening rim for receiving the opening of the cover portion. The opening rim of the tray portion can have a length dimension and a breadth dimension perpendicular to the length dimension, wherein the opening of the cover portion has the same length and breadth dimensions as the opening rim of the tray portion so that the opening of the cover portion must be biased inward, accommodated by the open ended slots, in order for the cover portion to be seated in the tray portion. The tray portion can have a bottom panel and an opening rim opposite the bottom panel, wherein the open ended slots are defined in the cover portion and, when seated in the tray portion, at least one of the open ended slots extends in a vertical direction from the bottom panel to a height above the opening rim.

The cover portion can include top flaps configured to form an upper closure of the cover portion. The tray portion can include bottom flaps opposite the top flaps configured to form a bottom panel of the tray portion. The tray portion can include stacking slots defined in at least one of the bottom panel, a front panel, and/or a back panel of the tray portion. The cover portion can include stacking tabs extending from at least one of the upper closure, a front panel, and/or a back panel of the cover portion. The stacking tabs can be configured to be received in stacking slots of another container stacked on top of the cover portion. The stacking slots can be configured to receive the stacking tabs of another container stacked below the tray portion. The tray portion can include a pair of side panels opposite from another. A height dimension of one of the side panels of the tray portion can be less than a height dimension of the other side panel.

An adhesion tab extending from a side panel of the tray portion can be adhered to a front panel or a back panel of the tray portion. In accordance with some embodiments, the adhesion tab can extend from the front or back panel of the tray portion and be adhered to a side panel of the tray portion. The side panel of the tray can have a width dimension that is less than a width dimension of the front panel of the tray and less than a width dimension of the back panel of the tray. In accordance with some embodiments, adhesion tab extends from a back or front panel and is adhered to a side panel of the cover portion, or adhesion tab can extend from a side panel and be adhered to a back or front panel of the cover portion.

A blank for a container includes a tray portion and a cover portion connected to the tray portion across a break line. The tray portion includes a pair of bottom closure flaps, a front bottom panel flap, a back bottom panel flap, a respective side panel connected to each of the bottom closure flaps along a respective fold line, a front panel connected to the front bottom panel flap along a fold line, and a back panel connected to the back bottom panel flap along a fold line. The front and back panels are connected to respective ones of the side panels along a plurality of vertical fold lines. The cover portion includes a pair of top closure flaps, a front top panel flap, a back top panel flap, a respective side panel connected to each of the top closure flaps along a respective fold line, a front panel connected to the front top panel flap along a fold line, and a back panel connected to the back top panel flap along a fold line. The front and back panels of the cover portion are connected to respective ones of the side panels of the cover portion along a plurality of vertical fold lines.

The vertical fold lines of the cover portion can be aligned in line with respective ones of the vertical fold lines of the tray portion. Open ended slots can be defined in the cover portion. The open ended slots of the cover portion can separate the vertical fold lines of the tray portion from the respective vertical fold lines of the cover portion. Each of the open ended slots can abut the break line. The break line can be weakened to facilitate breaking the tray portion from the cover portion by at least one of a knife cut and/or perforations.

The tray portion can include at least one stacking slot. The cover portion can include cut lines defining at least one stacking tab. The side panels, front panel, and/or back panel of the cover portion can include at least one of handle holes and/or breathability apertures defined therethrough. Each of the front top panel flap, the back top panel flap, the front bottom panel flap, and the back bottom panel flap can include at least one closure aperture configured to receive a respective one of the closure flaps.

One of the side panels can have a first height dimension and another side panel has a second height dimension smaller than the first height dimension. At least one of the front panel or the back panel of the tray portion can include a sloped edge extending between the side panels of the tray portion. The sloped edge of at least one of the front panel or the back panel of the tray portion can be opposite from the break line across the at least one of the front panel or the back panel. At least one of the front panel or the back panel of the tray portion can include a respective edge extending between the side panels of the tray portion. The respective edge can be opposite from the break line across at least one of the front panel or the back panel. At least one slot can be defined through the tray portion and the cover portion across the break line. The front top panel flap, the back top panel flap, the front bottom panel flap, and/or the back bottom panel flap can include at least one closure aperture configured to receive a respective one of the closure flaps. The blank can be folded along two of the vertical fold lines and the tray portion can be adhered to itself and the cover portion can be adhered to itself with the break line unbroken. An adhesion tab can extend from a side panel of at least one of the cover portion or the tray portion. The side panel of at least one of the cover portion or the tray portion can have a width dimension that is less than a width dimension of the front or back panel of the cover portion or the tray portion. An adhesion tab can extend from a back or front panel of at least one of the tray portion or the cover portion.

A method of forming a container includes forming a blank as described above, including forming the break line by at least one of knife cutting and/or perforating the blank. Forming the blank can include forming a sloped edge on at least one of the front or back panels. The sloped edge can be formed by knife cutting and is defined between respective vertical fold lines. The method can include folding the blank along two of the vertical fold lines, adhering the tray portion to itself, and/or adhering the cover portion to itself. Adhering the tray portion to itself can include adhering an adhesion tab that extends from a side panel of the tray portion to the front panel or the back panel of the tray portion. Adhering the cover portion to itself can include adhering an adhesion tab that extends from a side panel of the cover portion to the front panel or the back panel of the cover portion.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded perspective view of an exemplary embodiment of a container constructed in accordance with the present disclosure, showing the tray portion assembled with product therein, and showing the cover portion assembled prior to seating the cover portion in the tray portion to enclose the product;

FIG. 2 is a perspective view of a portion of the container of FIG. 1, showing one of the open ended slots of the cover portion;

FIG. 3 is a plan view of a blank for making the container of FIG. 1, showing the blank prior to assembling into the configuration of FIG. 1;

FIG. 4 is a perspective view of the blank of FIG. 3, showing the container in a flattened state;

FIG. 5 is a perspective view of the container of FIG. 4, showing the cover portion broken apart from the tray portion;

FIG. 6 is a perspective view of the container of FIG. 1, showing the cover portion seated in the tray portion to enclose the product in the fully assembled container;

FIG. 7 is a perspective view of a portion of the container of FIG. 6, showing a portion of the open ended slot of FIG. 2 with the cover portion seated in the tray portion;

FIG. 8 is an exploded perspective view of a plurality of containers of FIG. 1, showing how the containers can be stacked;

FIG. 9 is a plan view of another embodiment of a blank constructed in accordance with the present disclosure prior to assembling into its container configuration, showing an inner surface of the container;

FIG. 10 is a perspective view of the blank of FIG. 9, showing the container in a flattened state;

FIG. 11 is a perspective view of the container of FIG. 10, showing the cover portion broken apart from the tray portion;

FIG. 12 is a plan view of another embodiment of a blank constructed in accordance with the present disclosure prior to assembling into its container configuration, showing an outside surface of the container;

FIG. 13 is a perspective view of the blank of FIG. 12, showing the container in a flattened state;

FIG. 14 is a perspective view of the container of FIG. 13, showing the cover portion broken apart from the tray portion;

FIG. 15 is a plan view of another embodiment of a blank constructed in accordance with the present disclosure prior to assembling into its container configuration, showing an inside surface of the container;

FIG. 16 is a perspective view of the blank of FIG. 15, showing the container in a flattened state;

FIG. 17 is a perspective view of the container of FIG. 16, showing the cover portion broken apart from the tray portion;

FIG. 18A is an exploded perspective view of another exemplary embodiment of a container constructed in accordance with the present disclosure, showing the tray portion assembled with product therein, and showing the cover portion assembled prior to seating the cover portion in the tray portion to enclose the product;

FIG. 18B is a perspective view of the container of FIG. 18A, showing the cover portion seated in the tray portion to enclose the product in the fully assembled container;

FIG. 18C is a perspective view of a portion of the container of FIG. 18B, showing a portion of the open ended slot with the cover portion seated in the tray portion;

FIG. 19 is a plan view of a blank for making the container of FIG. 18A, prior to assembling into the configuration of FIG. 18A, showing an inside surface of the container;

FIG. 20 is a perspective view of the blank of FIG. 19, showing the container in a flattened state;

FIG. 21 is a perspective view of the container of FIG. 20, showing the cover portion broken apart from the tray portion;

FIG. 22 is a plan view of another embodiment of a blank constructed in accordance with the present disclosure prior to assembling into its container configuration, showing an inside surface of the container;

FIG. 23 is a perspective view of the blank of FIG. 22, showing the container in a flattened state;

FIG. 24 is a perspective view of the container of FIG. 23, showing the cover portion broken apart from the tray portion;

FIG. 25 is a plan view of another embodiment of a blank constructed in accordance with the present disclosure prior to assembling into its container configuration, showing an inside surface of the container;

FIG. 26 is a perspective view of the blank of FIG. 25, showing the container in a flattened state;

FIG. 27 is a perspective view of the container of FIG. 26, showing the cover portion broken apart from the tray portion;

FIG. 28 is a plan view of another embodiment of a blank constructed in accordance with the present disclosure prior to assembling into its container configuration, showing an inside surface of the container;

FIG. 29 is a perspective view of the blank of FIG. 28, showing the container in a flattened state; and

FIG. 30 is a perspective view of the container of FIG. 29, showing the cover portion broken apart from the tray portion.

### DETAILED DESCRIPTION OF THE PREFERRED EMBODIMENTS

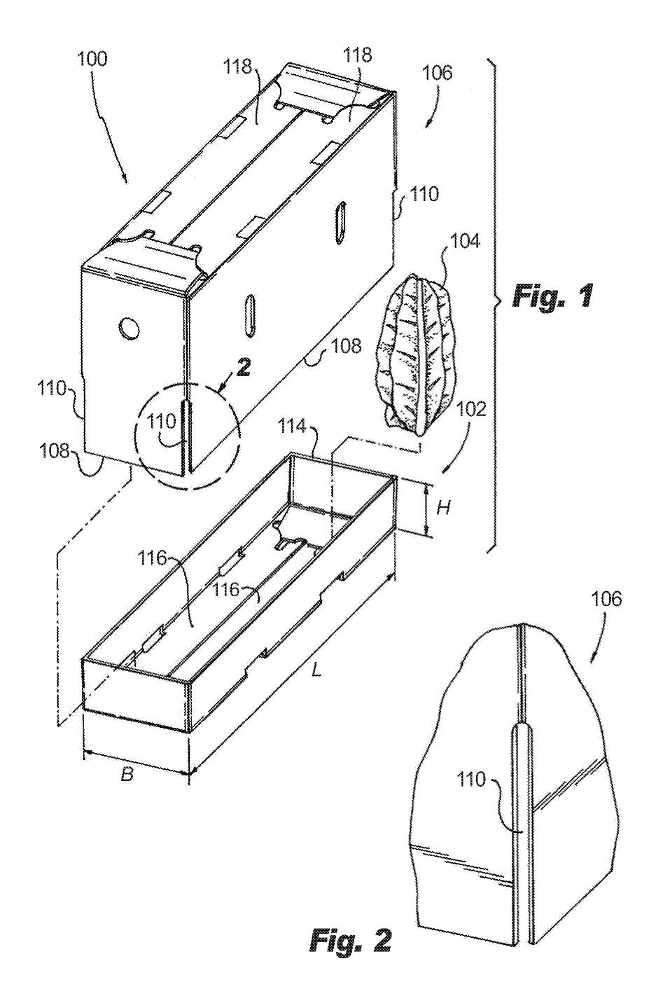

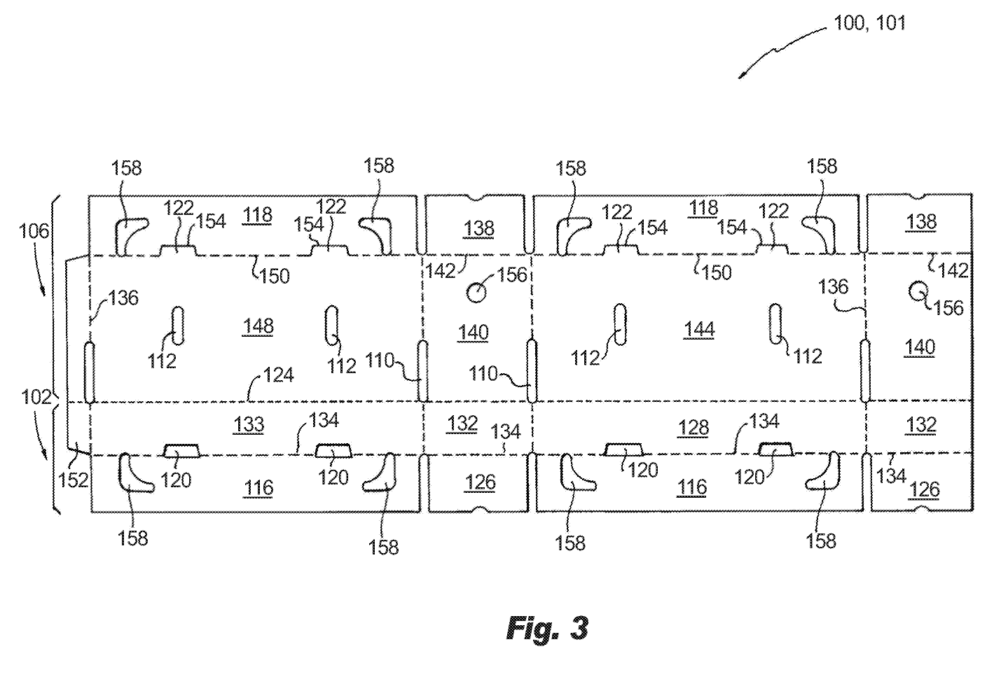

Reference will now be made to the drawings wherein like reference numerals identify similar structural features or aspects of the subject disclosure. For purposes of explanation and illustration, and not limitation, a partial view of an exemplary embodiment of a container in accordance with the disclosure is shown in FIG. 1 and is designated generally by reference character 100. Other embodiments of containers in accordance with the disclosure, or aspects thereof, are provided in FIGS. 2-30, as will be described. The systems and methods described herein can be used to ship and/or store product and can also be converted to display product such as in a retail setting.

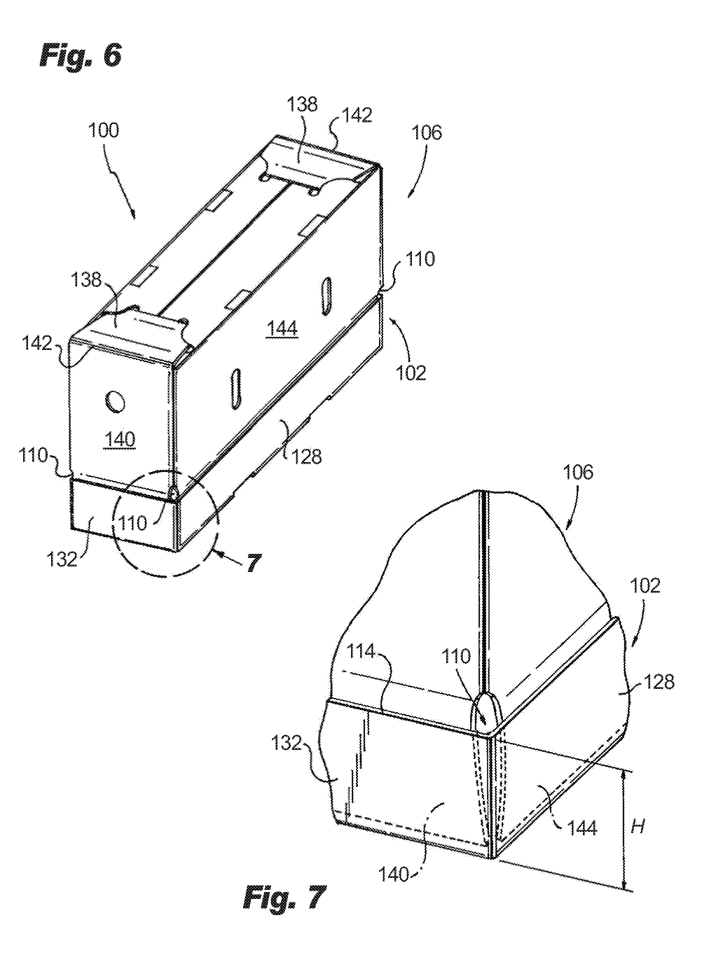

The container 100 includes a tray portion 102 configured for holding and displaying product 104. A cover portion 106 can be seated in the tray portion 102 for forming an enclosure around product 106 in the tray portion 102, as shown in the fully assembled container 100 in FIG. 6. The tray portion 102 and the cover portion 106 have the same length L and breadth B. An opening 108, i.e., the opening on the bottom of the cover portion 106 as oriented in FIG. 1, that is ultimately seated in the tray portion 102 is slotted with open ended slots 110 to allow the opening 108 to be biased inward, shrinking the length and breadth of the opening 108 so it can fit within and be seated in the tray portion 102. As shown in FIG. 2, the open ended slots 110 are in corner edges of the cover portion 106.

With reference again to FIG. 1, the tray portion 102 defines an opening rim 114 for receiving the opening 108 of the cover portion 106. The opening rim 114 of the tray portion has a length dimension L and a breadth dimension B perpendicular to the length dimension, wherein the opening 108 of the cover portion 106 has the same length and breadth dimensions L and B as the opening rim 114 so that the opening 108 of the cover portion 106 must be biased inward, shrinking inward accommodated by the open ended slots 110, in order for the cover portion 106 to be seated in the tray portion 102. In alternative embodiments, it is also contemplated that, in order for the cover portion 106 to be seated in the tray portion 102, one or more panels 140, 144 or 148 are biased inward and to fit within the bottom tray and the remaining panels 140, 144 or 148 go over the outside edges of the tray. For example, both side panels 140 can be biased inward as shown in FIG. 7, but panels 144 and 148 would remain outside of the tray portion 102.

The tray portion 102 has a bottom panel formed of two opposed bottom panel flaps 116 and the opening rim 114 is opposite the bottom panel. As shown in FIG. 7, when the open ended slots 110 of the cover portion 106 are seated in the tray portion 102, they extend in a vertical direction from the bottom panel 116 to a height above the opening rim 114. The height of the slots 110 in their longitudinal direction is thus longer than the height dimension H of the tray portion 10. Those skilled in the art will readily appreciate that slot heights less than, equal to, or greater than the height dimension H of the tray portion 102 can be used as appropriate to allow the cover portion 106 to be compressed to fit into the tray portion 102 for any given application. The cover portion includes front and back top flaps 118 configured to form an upper closure or panel of the cover portion 106. The tray portion 102 includes bottom flaps 116 opposite the top flaps 118 when the container 100 is fully assembled as shown in FIG. 6, to form the bottom panel of the tray portion 102. The cover portion 106 includes breathability apertures 112 completely defined through one or more walls thereof in addition to the open ended slots 110.

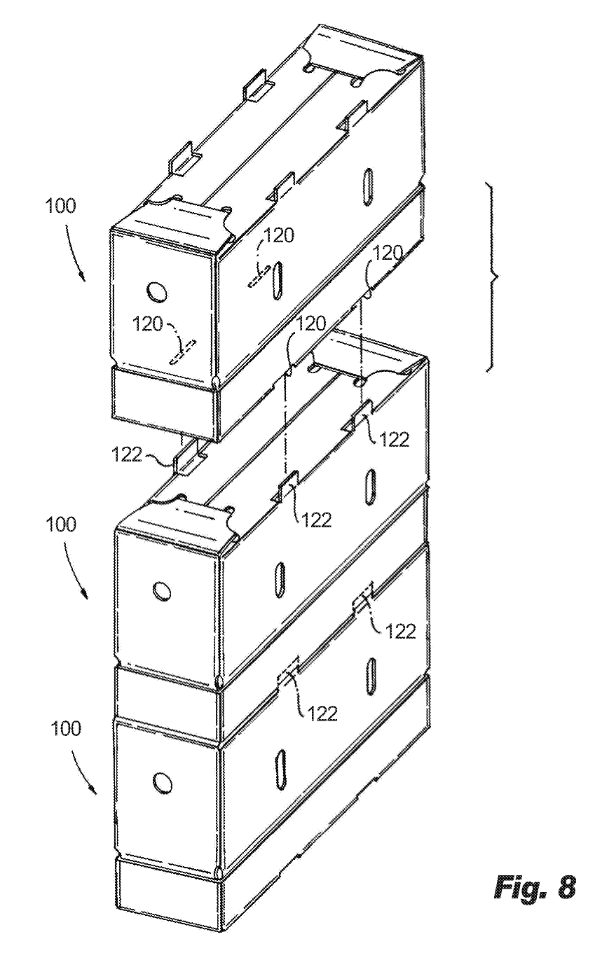

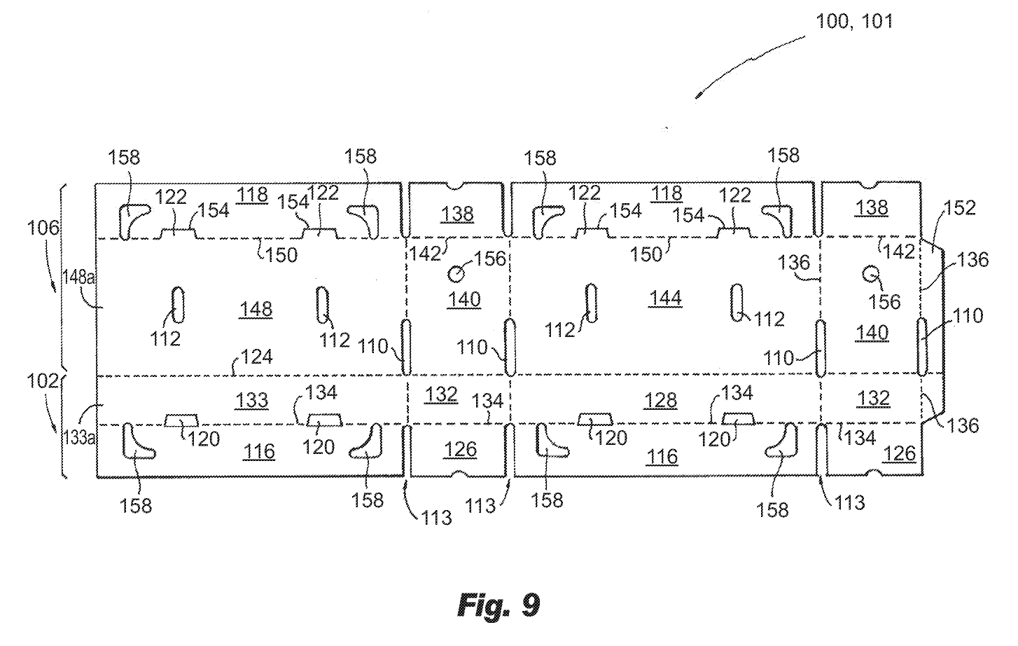

With reference now to FIG. 8, the tray portion 102 optionally includes stacking slots 120 defined in at least one of the bottom panel, the front panel 128, and/or back panel 133 of the tray portion 102. The cover portion 106 optionally includes stacking tabs 122 extending from at least one of the upper closure, the front panel 144, and/or the back panel 148 of the cover portion 106. The stacking tabs 122 are configured to be received in stacking slots 120 of another container 100 stacked on top of the cover portion 106. The stacking slots 120 are similarly configured to receive the stacking tabs 122 of another container 100 stacked below the tray portion 102 to form a registered stack as indicated in FIG. 8.

With reference now to FIG. 3, the blank 101 for the container 100 includes the tray portion 102 and the cover portion 106 connected to the tray portion 102 across a break line 124. The tray portion 102 includes a pair of bottom closure flaps 126, a front bottom panel flap 116, and a back bottom panel flap 116. A respective side panel 132 is connected to each of the bottom closure flaps 126 along a respective fold line 134. A front panel 128 is connected to the front bottom panel flap 116 along a fold line 134. A back panel 133 is connected to the back bottom panel flap 116 along a fold line 134. The front and back panels 128 and 133 are connected to respective ones of the side panels 132 along a plurality of vertical fold lines 136.

With continuing reference to FIG. 3, the cover portion 106 includes a pair of top closure flaps 138, a front top panel flap 118, and a back top panel flap 118. A respective side panel 140 is connected to each of the top closure flaps 138 along a respective fold line 142. A front panel 144 is connected to the front top panel flap 118 along a fold line 146. A back panel 148 is connected to the back top panel flap 118 along a fold line 150. The front and back panels 144 and 148 of the cover portion 106 are connected to respective ones of the side panels 140 of the cover portion 106 along the same plurality of vertical fold lines 136 that are described above with respect to tray portion 102. An adhesion tab 152 is defined across break line 124 connecting to panels 132 and 148 of the tray portion 102 and cover portion 106 along one of the vertical fold lines 136.

The vertical fold lines 136 of the cover portion 106 are thus aligned in line with respective ones of the vertical fold lines 136 of the tray portion 102. The open ended slots 110 are defined in the cover portion 106. The open ended slots 110 of the cover portion 106 separate the vertical fold lines 136 of the tray portion 102 from the respective vertical fold lines 136 of the cover portion 106. Each of the open ended slots 110 abuts the break line 124 so the slots are open-ended when the break line 124 is broken. The break line 124 is weakened to facilitate breaking the tray portion 102 from the cover portion 106 by at least one of a knife cut and/or perforations.

The cover portion 106 includes cut lines 154 defining the stacking tab 122. The side panels 140 and front and back panels 144/148 of the cover portion 106 include at least one of handle holes 156 and/or breathability apertures 112 defined therethrough. Each of the front top panel flap 118, the back top panel flap 118, the front bottom panel flap 116, and the back bottom panel flap 116 includes at least one closure apertures 158 configured to receive a respective one of the closure flaps 126/138 for closing the bottom of tray portion 102 and the top of cover portion 106. Those skilled in the art will readily appreciate that in addition to or in lieu of closure apertures 158, any other suitable closure technique can be used, such as tape, adhesive, or combinations of tape and adhesive, without departing from the scope of this disclosure.

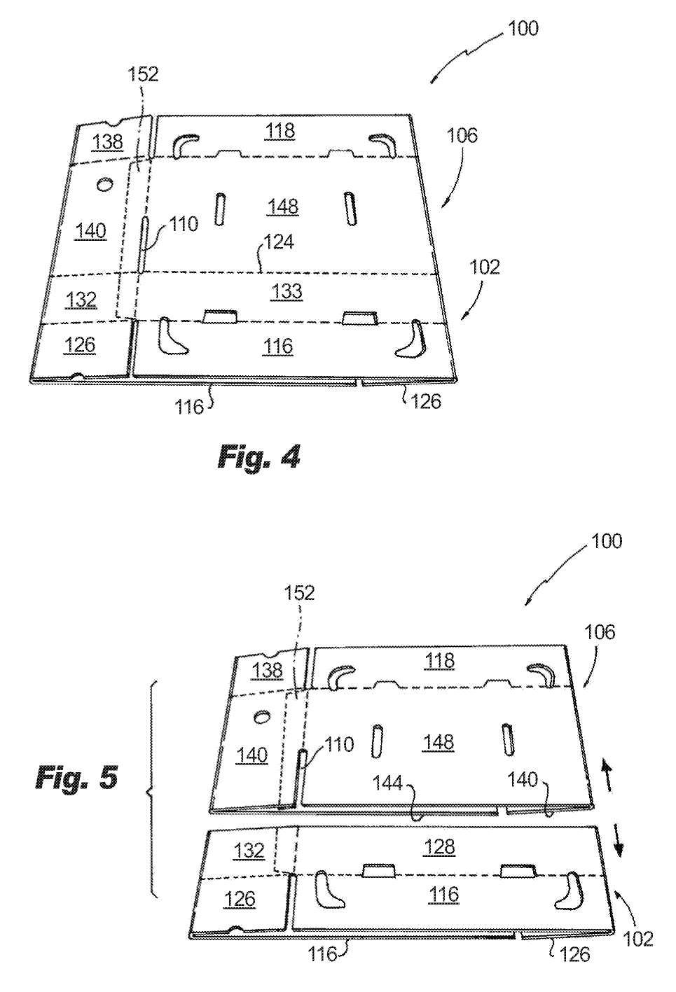

With reference to FIG. 4, the blank 101 is folded along two of the vertical fold lines 136. The tray portion 102 is adhered to itself using adhesion tab 152 and the cover portion is adhered to itself in the same manner with the break line 124 initially unbroken. In this state, shown in FIG. 4, a plurality of blanks 101 can be shipped from their place of manufacture to a location where they will be packed.

As shown in FIGS. 9-11, an alternative embodiment of a container 100 and a blank 101 include an adhesion tab 152 defined across break line 124 extending from panels 140 and 132. FIG. 9 shows an interior-side surface of the blank 101. The blank 101 and container 100 of FIGS. 9-11 are arranged in the same manner as the container 100 and the blank 101 of FIGS. 1-6. Except, however, in blank 101 of FIG. 9, the adhesion tab 152 extends from a “short side” of the blank 101, e.g. side panel 140 that defines the width, and adheres to an inner surface 148a of a back panel 148, e.g. one of the panels that defines the length. Vertical fold lines 136 are positioned between panels 140 and 132 and the adhesion tab 152, instead of back panel 148 and adhesion tab 152, as in FIGS. 1-8. Additionally, as shown in FIG. 9, the cut that forms open ended slot 110 between the adhesion tab and its abutting panel is now between the adhesion tab 152 and the side panel 140, instead of between the adhesion tab 152 and the back panel 148.

With continued reference to FIGS. 9-11, the blank 101 and the container 100 include a tray portion 102 and a cover portion 106 connected to the tray portion 102 across a break line 124. The tray portion 102 includes a pair of bottom closure flaps 126, a front bottom panel flap 116, and a back bottom panel flap 116, which are all the same as bottom closure flaps 126 and bottom panel flaps 116 of container 100 and blank 101 shown in FIGS. 1-8. A respective side panel 132 is connected to each of the bottom closure flaps 126 along a respective fold line 134. A front panel 128 and a back panel 133 are connected to at least one of bottom panel flaps 116 along respective fold lines 134. The front and back panels 128 and 133 are connected to respective ones of the side panels 132 along a plurality of vertical fold lines 136. Vertical fold lines are arranged in the same manner as those shown in FIGS. 1-8 and described above.

With reference now to FIG. 9, the cover portion 106 includes a pair of top closure flaps 138, a front top panel flap 118, and a back top panel flap 118, and respective fold lines 150, that are the same as those of container 100 and blank 101 shown in FIGS. 1-8. The side panel 140 is connected to each of the top closure flaps 138 along a respective fold line 142. A front panel 144 is the same as front panel 144 of FIGS. 1-8. The front and back panels 144 and 148 of the cover portion 106 of blank 101 of FIG. 9 connect with the side panel 140 without the adhesion flap 152 in the same manner as the blank/container 101-100 of FIGS. 1-8. Stacking tab 122 and cut lines 154, handle holes 156, breathability apertures 112, and closure apertures 158 are the same as those described above with respect to FIGS. 1-8.

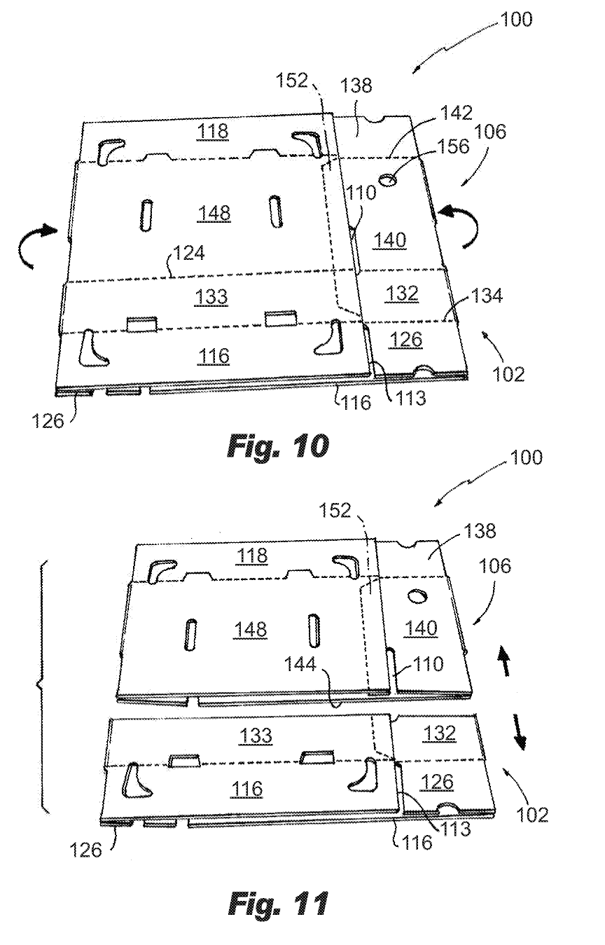

As shown in FIGS. 10-11, tray portion 102 is adhered to itself using adhesion tab 152 and the cover portion 106 is adhered to itself in the same manner with the break line 124 initially unbroken. In this state, the container 100 of FIG. 10 can be shipped from its place of manufacture to a location where it will be packed, similar to the embodiment above shown in FIGS. 1-8. In FIGS. 10-11, adhesion tab 152 is shown in broken lines to indicate that it is folded with respect to side panels 140 and 132. An outer surface of adhesion tab 152 adhered to an inner surface 133a of back panel 133 and an inner surface 148 of back panel 148. Other than the positioning of slot 110 between the adhesion tab 152 and its respective side panel 140, open ended slots 110 of the cover portion 106 are the same as those shown in FIGS. 1-8 and described above.

The container 100 of FIGS. 10-11 forms an enclosure around a product, e.g. product 104, in the same manner as the container 100 of FIGS. 1-8. The tray portion 102 and the cover portion 106 have the same length L and breadth B, in the same way as container 100 shown in FIGS. 1-8. An opening of the cover portion 106 is positioned and operates in the same manner as opening 108 of FIGS. 1-8. The open ended slots 110, a rim 114 of tray portion 102, and the opening of the cover portion of FIGS. 9-11 operate in the same manner as described above for FIGS. 1-8 and are dimensioned relative to one another in the same manner as container 100 of FIGS. 1-8. Those skilled in the art will readily appreciate that slot heights less than, equal to, or greater than the height dimension H of the tray portion 102 can also be used. In the same manner as the container 100 of FIGS. 1-8, the container 100 of FIGS. 9-11 optionally includes stacking slots 120 and stacking tabs 122. Containers 100 in accordance with FIGS. 9-11 would be stacked in the same manner as container 100 of FIG. 8.

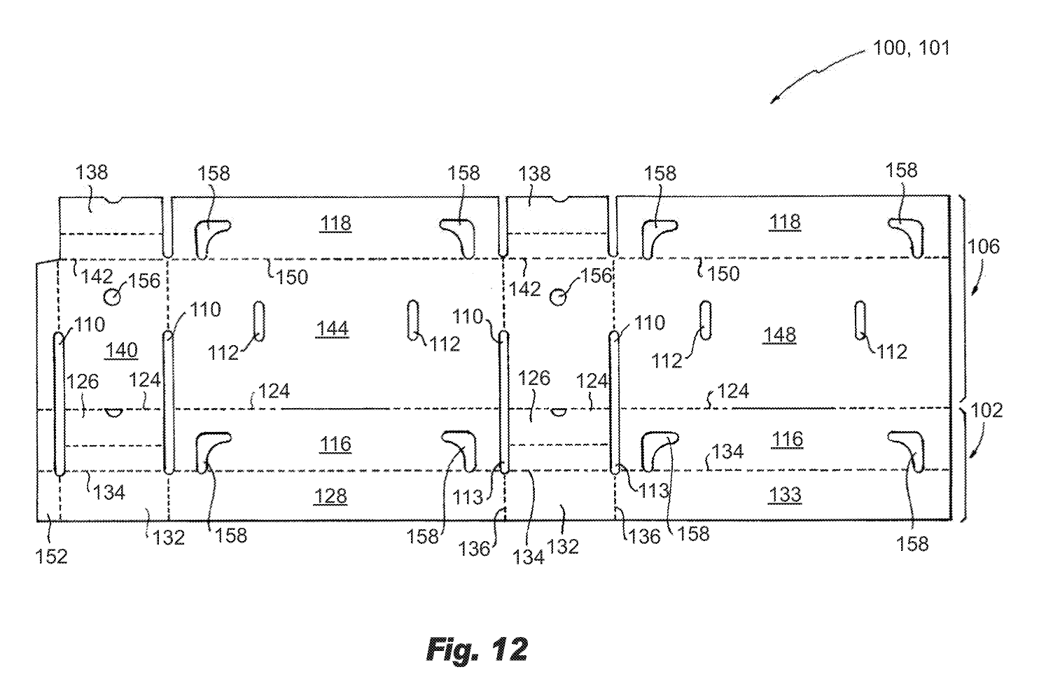

Now with reference to FIGS. 12-14, an alternative embodiment of blank 101 and container 100 are shown. The cover portion 106 of blank 101 and container 100 is the same as cover portion 106 of blank 101 and container 100 of FIGS. 9-11. Therefore, the description provided above for FIGS. 9-11 readily applies to cover portion 106 of blank 101 and container 100 of FIGS. 12-14. The tray portion 102 of blank 101 shown in FIGS. 12-14 varies from tray portion 102 of FIGS. 9-11 in that it is inverted. The tray portion 102 includes a pair of bottom closure flaps 126, a front bottom panel flap 116, and a back bottom panel flap 116. A respective side panel 132 is connected to each of the bottom closure flaps 126 along a respective fold line 134. A front panel 128 is connected to the front bottom panel flap 116 along a fold line 134. A back panel 133 is connected to the back bottom panel flap 116 along a fold line 134. The front and back panels 128 and 133 are connected to respective ones of the side panels 132 along a plurality of vertical fold lines 136, which are the same as vertical fold lines 136 of FIGS. 1-11.

In FIGS. 12-14, instead of having front and back panels 128 and 133 and side panels 132 abut break line, bottom closure flaps 126, a front bottom panel flap 116, and a back bottom panel flap 116 abut break line 124. In this arrangement, the edge that forms an upper rim 114 of tray portion 102 is cut as opposed to being generated when break line 124 is severed/broken. This allows for upper rim 114 to be free of the nicks typically left when break line 124 is torn, allowing for a smoother upper rim 114. In the blank 101 of FIGS. 9-11, slots 113 between panels of the tray portion 102, face away from open ended slots 110 of the cover portion 106. In blank 101 shown in FIGS. 12-14, slots 113 face towards and are aligned with open ended slots 110 such that, when in blank form, they form a single slot 110 across break line 124.

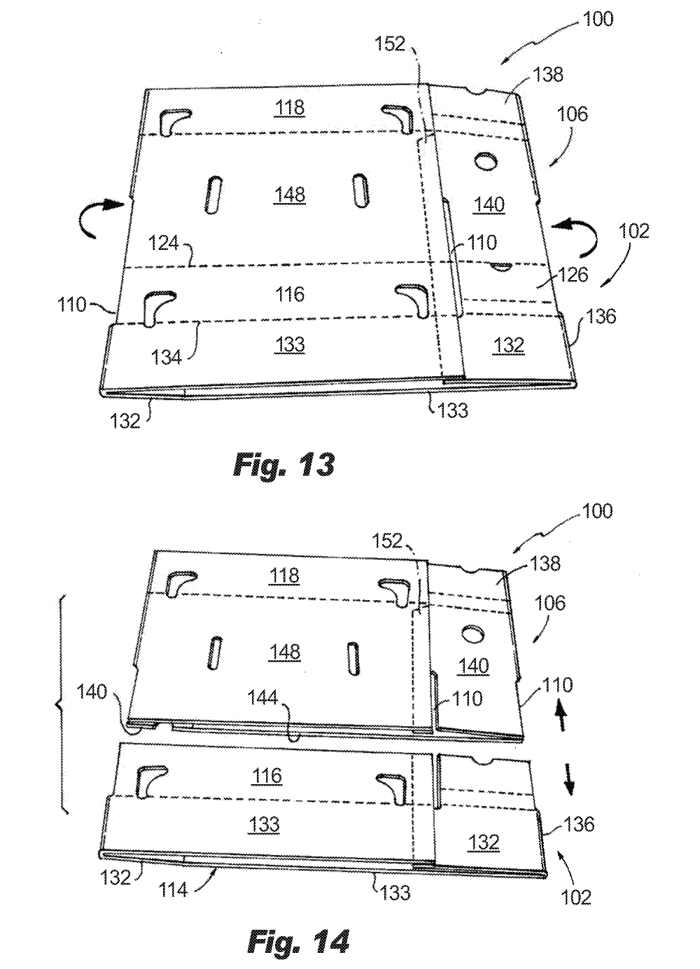

In FIGS. 12-14, adhesion tab 152 is shown in broken lines to indicate that it is folded with respect to end panels 140 and 132 and ultimately is positioned within the container 100. Adhesion tab 152 of FIGS. 12-14 is the same as that of FIGS. 9-11, in that it extends from a short side and adheres to a long side. However, adhesion tab 152 of FIGS. 12-14 is longer than adhesion tab 152 of FIGS. 9-11 so that adhesion tab 152 remains foldably attached to its respective side panel 132 after break line 124 is severed/broken. Because adhesion tab 152 extends from a short side, e.g. from side panel 132 and bottom closure flap 126, and is adhered to a long side, e.g. side panel 133 and bottom panel flap 116, the portion of bottom closure flap 126 that is secured into closure apertures 158 remains a single ply. This tends to be easier for securing container 100 after folding. The break line 124 is weakened to facilitate breaking the tray portion 102 from the cover portion 106 by at least one of a knife cut and/or perforations. A plurality of blanks 101, like those of FIG. 13, can be shipped from their place of manufacture to a location where they will be packed, similar to the embodiment above shown in FIGS. 1-8.

The container 100 of FIGS. 13-14 is the same as the containers 100 of FIGS. 1-11 in that a cover portion 106 can be seated in the tray portion 102 for forming an enclosure around product 106 in the tray portion 102. Once in container form, the opening of the cover portion, opening rim 114 of tray portion 102, the open ended slots 110, and the respective dimensions of the tray and cover portions, are all the same as those described in FIGS. 1-8 and operate in a similar manner so that the cover portion can be seated in the tray portion in the same manner as shown in FIGS. 1-8. Container 100 of FIGS. 12-14, however, may have a smoother edge on opening rim 114 of tray portion than containers 100 of FIGS. 1-11, which may be desired in some commercial settings.

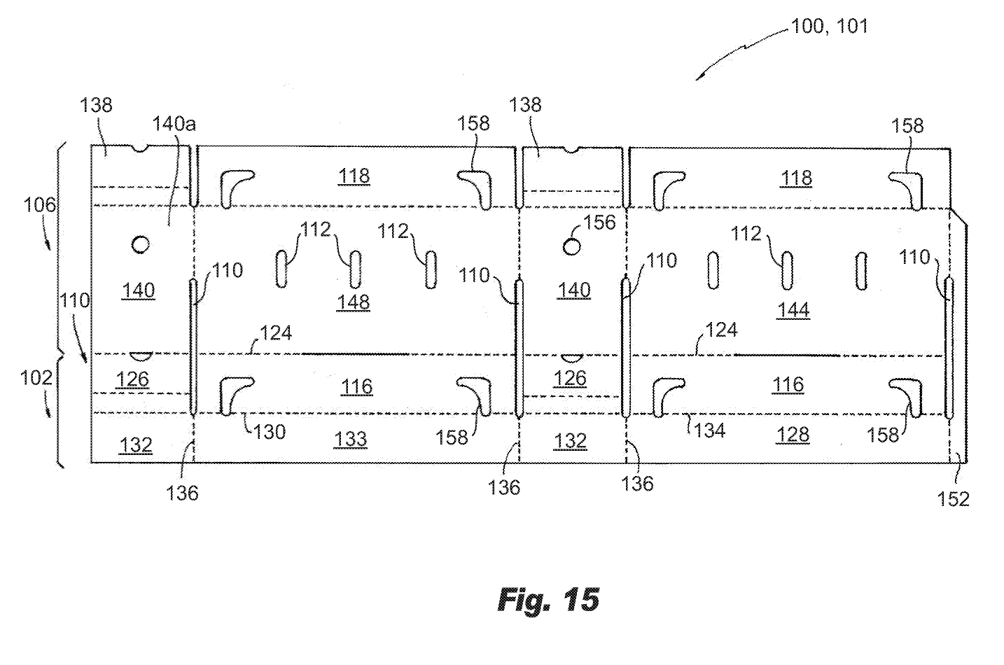

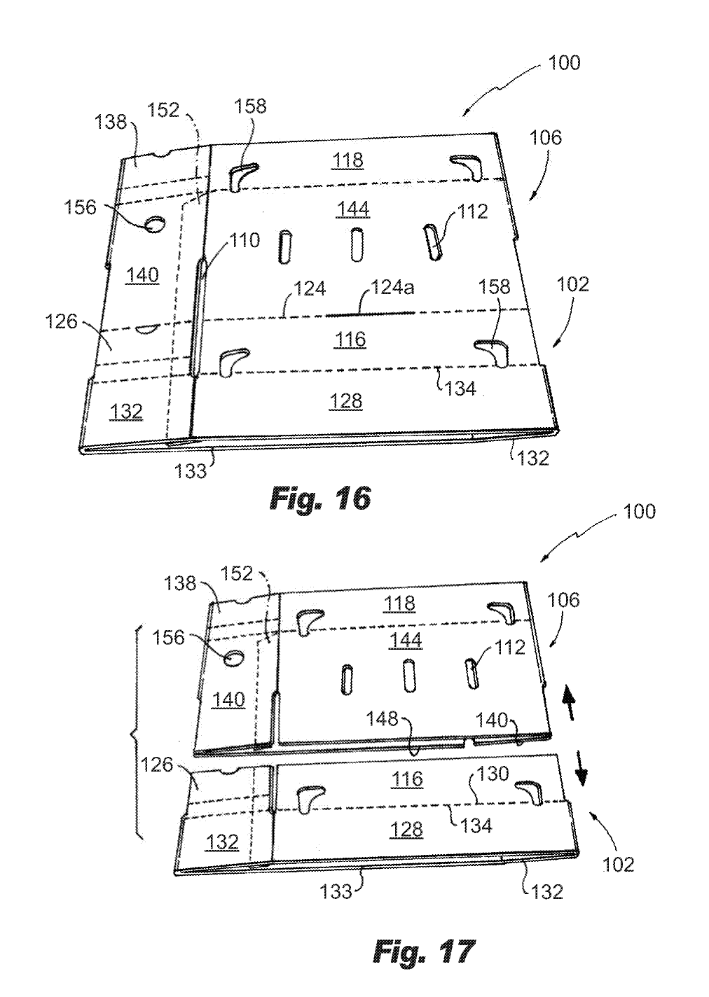

With reference now to FIGS. 15-17, a cover portion 106 of blank 101 and container 100 of FIGS. 15-17 is the same as cover portion 106 of blank 101 and container 100 of FIGS. 3-8. Therefore, the description provided above for cover portion 106 of FIGS. 3-8 readily applies to cover portion 106 of blank 101 and container 100 of FIGS. 15-16. The tray portion 102 of blank 101 and container 100 of FIGS. 15-17 differ from tray portion 102 of FIGS. 3-5 in that bottom closure flaps 126, a front bottom panel flap 116, and a back bottom panel flap 116 of tray portion 102 of FIGS. 15-17 abut break line 124. Bottom closure flaps 126, a front bottom panel flap 116, and a back bottom panel flap 116 of FIGS. 15-17 abut break line 124 in the same manner as FIGS. 12-14. Similar to upper rim 114 of FIGS. 12-14, this allows for an upper rim 114 of tray portion 102 of FIGS. 15-17 to be formed with a cut, as opposed via tearing of the break line 124. This allows for a smoother edge on upper rim 114 of tray portion 102 of FIGS. 15-17 without nicks. Those skilled in the art will readily appreciate that break line 124 can be formed by at least one of knife cutting and/or perforating the blank. In FIG. 16, the knife cut in break line 124 is schematically indicated by the solid line 124a between the two perforated lines. Those skilled in the art will readily appreciate that a variety of weakening mechanisms can be used in a single break line.

The only difference between blank 101 and container 100 of FIGS. 15-17 and blank 101 and container 100 of FIGS. 12-14 is that the adhesion tab 152 extends from a front panel 144 of container 100 in FIGS. 15-17, e.g. a long side, and adheres to an inside surface 140a of end panel 140, e.g. a short side. It is also contemplated that adhesion tab 152 of FIGS. 15-17 could also adhere to an outer surface of front panel 140. Similar to FIGS. 12-14, adhesion tab 152 of FIGS. 15-17 is longer than that of FIGS. 9-11 so that adhesion tab 152 remains foldably attached to its respective side panel 132 after the break line 124 is severed/broken. This results in a portion of adhesion tab 152 being adhered to an inner surface of a bottom closure flap 126.

As described above for FIGS. 1-8, to close the bottom panel of tray portion 102 bottom closure flap 126 is secured into closure aperture 158 on bottom flap 116. As a portion of adhesion tab 152 is positioned on the inner surface of closure flap 126, two plies of material (e.g. cardboard, or the like) have to be engaged with closure aperture 158 in order to secure closure flap 126 onto bottom flap 116. This tends to be more difficult than securing one ply of material in aperture 158, e.g. as with containers 100 shown in FIGS. 1-14. Cover portion 106 can be seated in the tray portion 102 in the same manner as shown in FIGS. 6-7. While not shown, the embodiments of container 100 shown in FIGS. 12-14 and 15-17 can optionally include stacking slots, e.g. stacking slots 120 of FIGS. 1-8, and stacking tabs, e.g. stacking tabs 122 of FIGS. 1-8. Containers 100 in accordance with FIGS. 12-14 and 15-17 can be stacked in a similar manner to the stacking shown in FIG. 8.

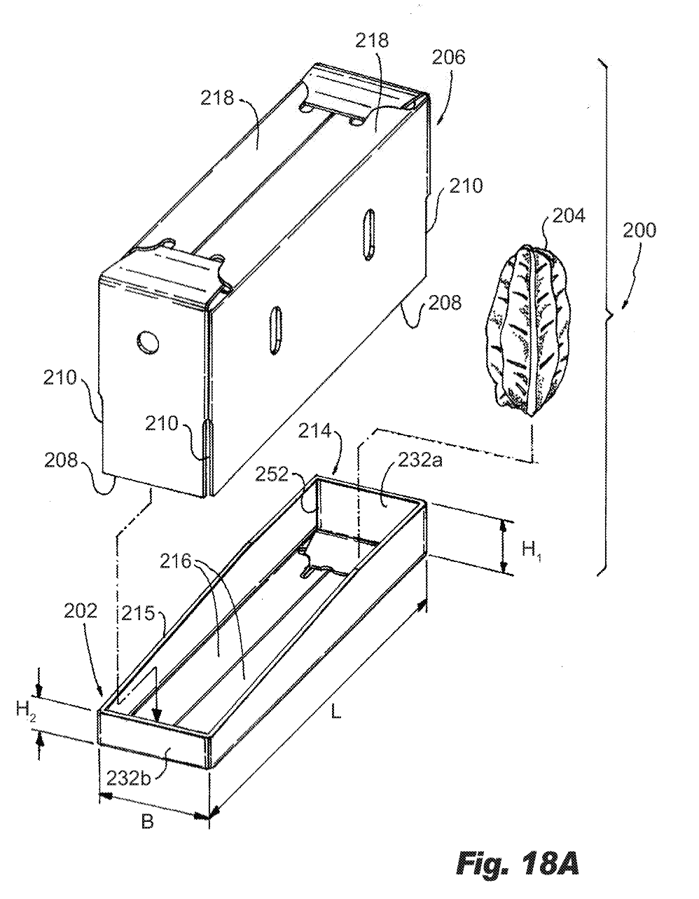

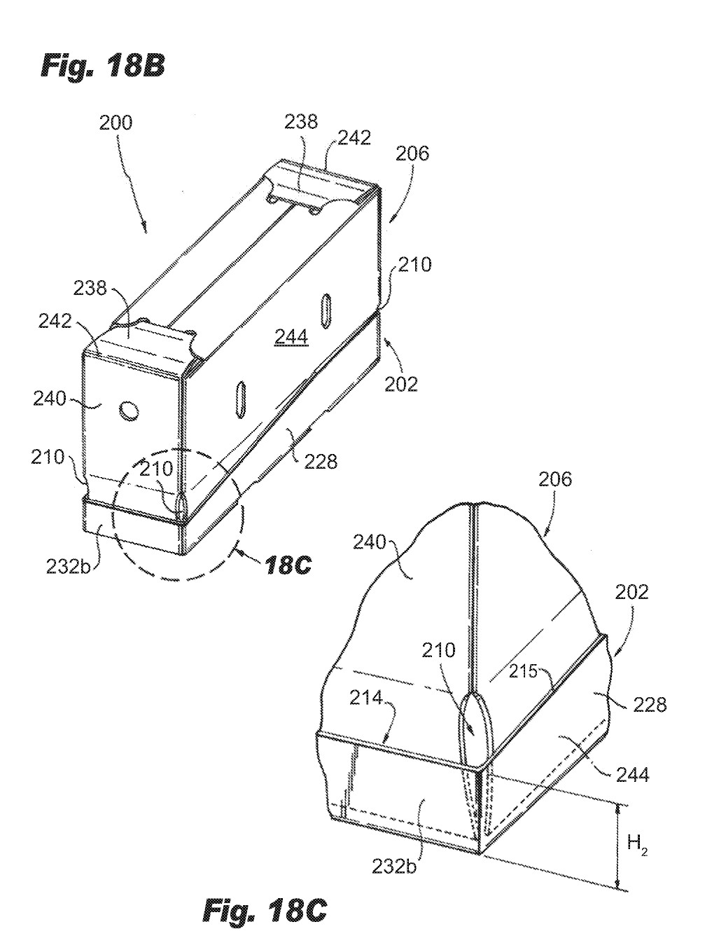

As shown in FIGS. 18A-18C, an alternative embodiment of a container 200 and blank 201 includes an angled upper edge 215 on a tray portion 202 that is configured for holding and displaying product 204. As shown in FIG. 18B, cover portion 206 can be seated in the tray portion 202, similar to cover portion 106 and tray portion 102. The cover portion 206 is the same as cover portion 106 of FIG. 12. Therefore, the description provided above for cover portion 106 of FIG. 12 and its components readily applies to cover portion 206 of blank 201 and container 200. The tray portion 202 and the cover portion 206 have the same length L and breadth B. As shown in FIG. 18A, the tray portion 202 defines an opening rim 214 for receiving the opening 208 of the cover portion 206. The opening rim 214 of the tray portion has a length dimension L and a breadth dimension B perpendicular to the length dimension, wherein the opening 208 of the cover portion 206 has the same length and breadth dimensions L and B as the opening rim 214 so that an opening 208, i.e., the opening on the bottom of the cover portion 206 as oriented in FIG. 18A, of the cover portion 206 must be biased inward, in the same manner as container 100 shown in FIGS. 1 and 6-7 and described above. As shown in FIG. 18B, when open ended slots 210 of the cover portion 206 are seated in the tray portion 202, they extend in a vertical direction in the same manner as open ended slots 110 of container 100 shown in FIG. 12.

As shown in FIGS. 18A-18C, the tray portion 202 has a bottom panel formed of two opposed bottom panel flaps 216, e.g. the same as bottom flaps 116 described above and shown in FIGS. 1-8 and 12-14, and the opening rim 214 is opposite the bottom panel. The tray portion 202 is the same as tray portion 102 of FIG. 12, except that a front panel 228 and a back panel 233 have sloped upper edges 215 that slope downward between one side panel 232a and the other side panel 232b. Tray portion 202 has a first height dimension H₁ defined by side panel 232a and a second height dimension defined by side panel 232b. The height dimension of the tray portion 202 varies along the length dimension L of the tray due to the sloped front and back panels 228 and 233. The height of the slots 210 in their longitudinal direction is thus longer than both height dimensions H₁ and H₂ of the tray portion 202.

With continued reference to FIGS. 18A-18C, those skilled in the art will readily appreciate that slot heights less than, equal to, or greater than the height dimensions H₁ and H₂ of the tray portion 202 can be used as appropriate to allow the cover portion 206 to be compressed to fit into the tray portion 202 for any given application. In the embodiment of FIGS. 18A-18C, sloped edges 215 do not extend along the entire length of front and back panels 228 and 233. Instead, a portion of front and pack panels 228 and 233 proximate to the side panel 232a have the same height as side panel 232a. In accordance with some embodiments, however, it is contemplated that front and back panels 228 and 233 can include sloped edges 215 that extend the entire length of front and back panels 228 and 233, e.g. all the way from side panel 232a to side panel 232b. Container 200 can optionally include stacking slots, e.g. stacking slots 120 shown in FIGS. 1-8, and stacking tabs, e.g. stacking tabs 122 shown in FIGS. 1-8. The stacking slots and tabs are configured and operate in the same manner as stacking slots 120 and tabs 122 shown in containers 100 of FIGS. 1-8.

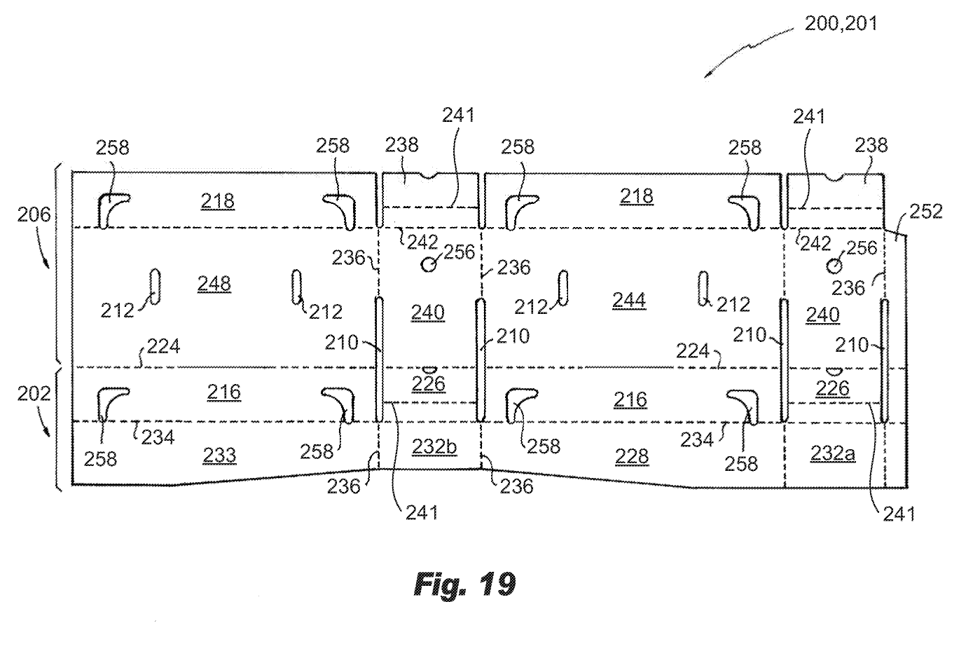

With reference now to FIG. 19, when container 200 is in the form of blank 201, the tray portion 202 is connected to the cover portion 206 a break line 224. The tray portion 202 includes a pair of bottom closure flaps 226, a front bottom panel flap 216, and a back bottom panel flap 216, which are all the same as those shown in FIGS. 12-14 and described above. A respective side panel 232a/232b is connected to each of the bottom closure flaps 226 along a respective fold line 234. A front panel 228 is connected to the front bottom panel flap 216 along a fold line 234. A back panel 233 is connected to the back bottom panel flap 216 along a fold line 234. The front and back panels 228 and 233 are connected to side panels 232a and 232b along a plurality of vertical fold lines 236. As described above, front and back panels 228 and 233 slope downward from side panel 232a to side panel 232b. This slope provides an alternative display option to those described in FIGS. 1-17, where the front of the tray portion 202 shows more of the product than the embodiments of tray portion 102, described above.

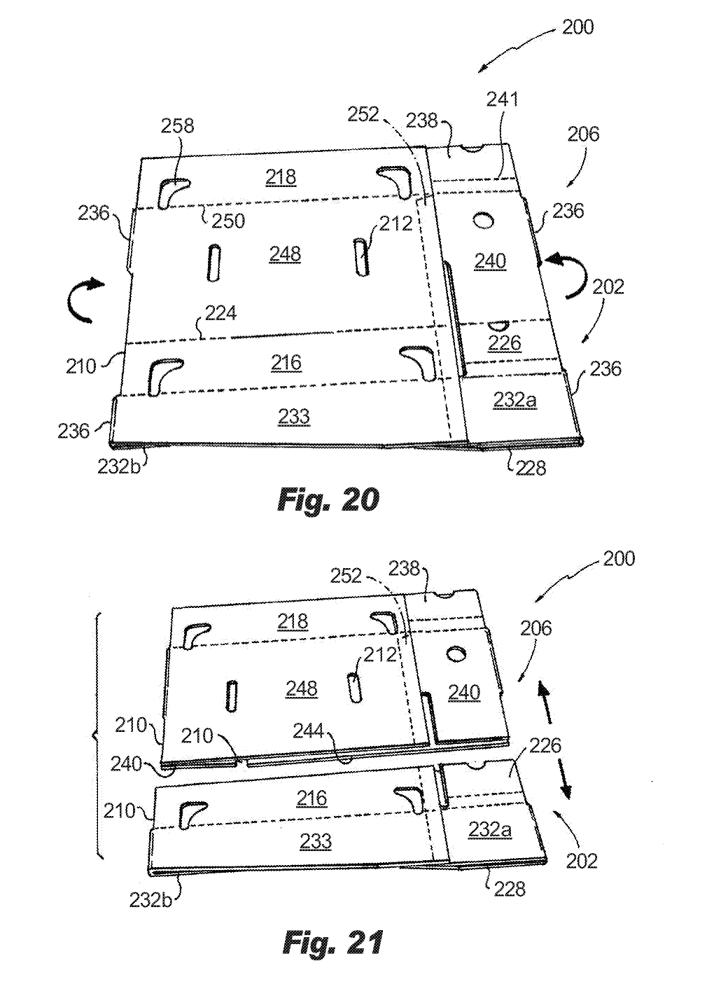

With reference to FIGS. 19-20, the cover portion 206 of blank 201/container 200 includes a pair of top closure flaps 238, side panels 240 and fold lines 242, a front panel 244, a back panel 248, a fold line 250, a top panel flap 218, a fold line 246, and handle holes 256 which are the same as closure flaps 138, side panels 140, fold lines 142, front panel 144, back panel 148, fold line 150, fold line 146, and handle holes 156 of container 100/blank 101 of FIGS. 12-14. An adhesion tab 252 is defined across break line 224 in the same manner as adhesion tab 152 of blank 101 of FIG. 12. The vertical fold lines 236, open ended slots 210, and break line 224 are oriented and function in the same manner as vertical fold lines 136, open ended slots 110 and break line 124 of blank 101/container 100 of FIG. 12. Blank 201/container 200 includes closure apertures 258 that are the same as closure apertures 158 of blank 101 shown in FIG. 12. Top closure flaps 238 and bottom closure flaps 226 each include respective fold lines or lines of weakness 241 that help allow top and bottom closure flaps 238 and 226 be bent and inserted into their respective closure apertures 258. To form the container 200 shown in FIGS. 20-21, the blank 201 is folded along two of the vertical fold lines 236. The tray portion 202 is adhered to itself using adhesion tab 252 and the cover portion is adhered to itself in the same manner, with the break line 224 initially unbroken. In this state, shown in FIG. 20, a plurality of blanks 201 can be shipped from their place of manufacture to a location where they will be packed.

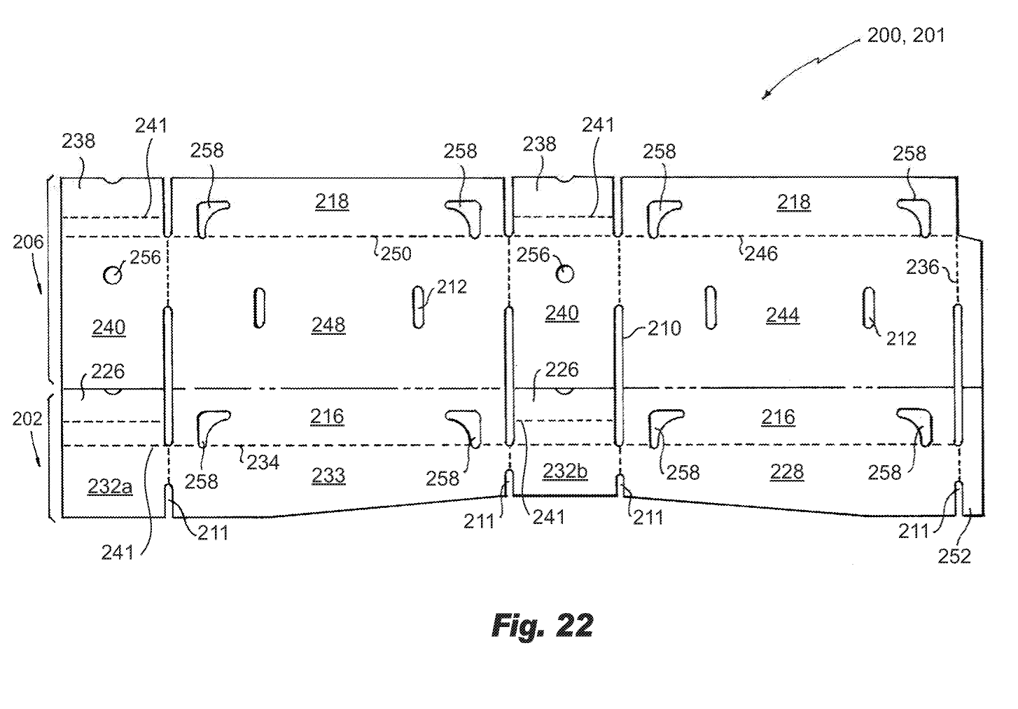

With reference now to FIG. 22, another embodiment of blank 201 is shown. FIG. 22 shows an inside surface of blank 201. Blank 201 of FIG. 22 is the same as blank 201 of FIG. 19 except that blank 201 of FIG. 22 has the adhesion flap 252 extending from a long side, i.e. panels 244, 228 and 216, to a short side, i.e. panels 240, 226 and 232a. Because adhesion flap 252 extends from panels 244, 216 and 228, slot 210 is defined between adhesion flap 252 and panels 224 and 216. Moreover, blank 201 of FIG. 22 also shows an alternative embodiment where tray portion 202 includes open ended slots 211. Open ended slots 211 allow side panels 232a, 232b and/or front and back panels 228 and 233 to be biased inward such that the panels of the cover portion, e.g. panels 244, 240, and 248 go over the outside edges of the tray. It is contemplated that if open ended slots 211 were included in tray portion 202, that open ended slots 210 of cover portion 206 would not be required. Instead, vertical fold lines 236 would extend from a top side of panels 244, 248 and 240 (e.g. the side of top closure flaps 218, 238) all the way to break line 224. Open ended slots 211 could similarly be included on any of the other embodiments described herein.

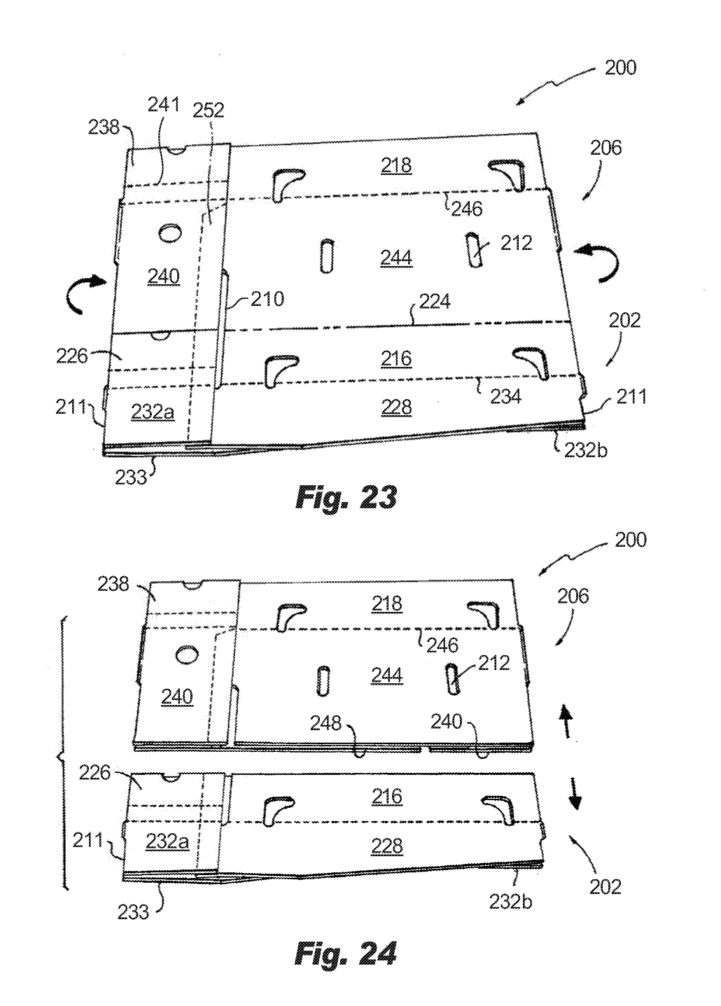

As shown in FIGS. 23-24, to form container 200 from the blank 201 of FIG. 22, an adhesion flap 252 is secured onto an inner surface of 232a, an inner surface one of bottom closure flaps 226, and an inner surface of side panel 240. The tray portion 202 is adhered to itself using adhesion tab 252 and the cover portion 206 is adhered to itself in the same manner with the break line 224 initially unbroken. In this state, shown in FIG. 23, a plurality of containers 200 can be shipped from their place of manufacture to a location where they will be packed. Once line of weakness 224 is broken/severed container 200 can be folded from its flattened state to form a container 200, in the same manner as container 200 shown in 18B. In this configuration, the portion of bottom closure flap 226 with the adhesion flap 252 adhered thereto is thicker than just the bottom closure flap 226 on its own and may be more difficult to secure within its respective closure aperture 228 once container 200 is folded from its flattened state. Once break line 224 is severed/broken slots 210 become open ended slots 210 on cover portion 206, which function in the same manner as slots 110 of container 100 shown in FIGS. 1-8.

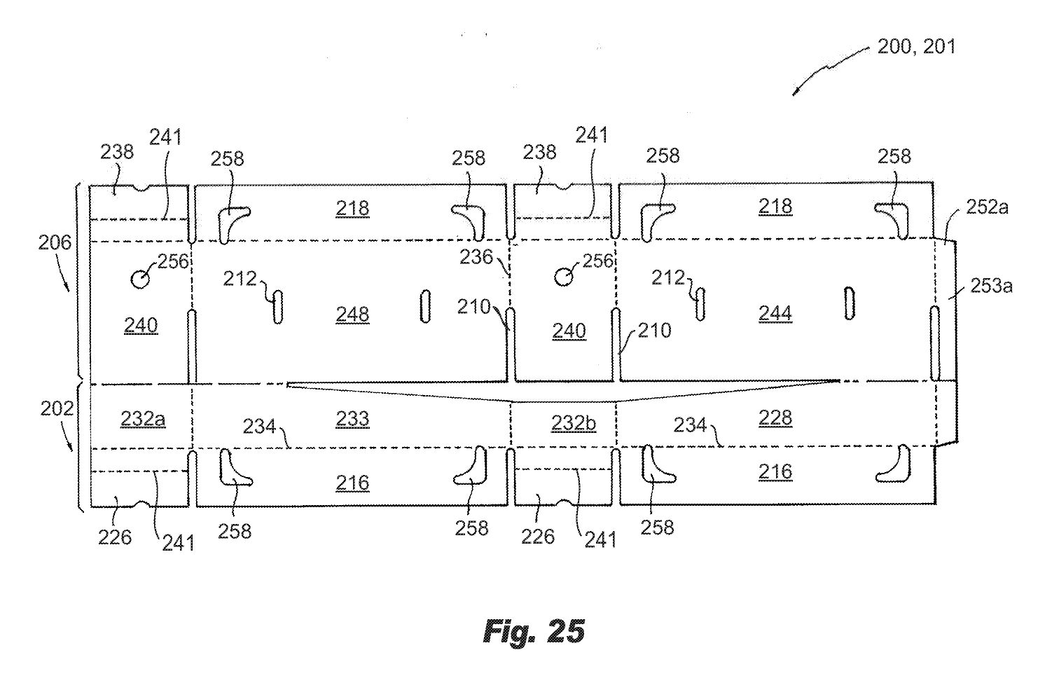

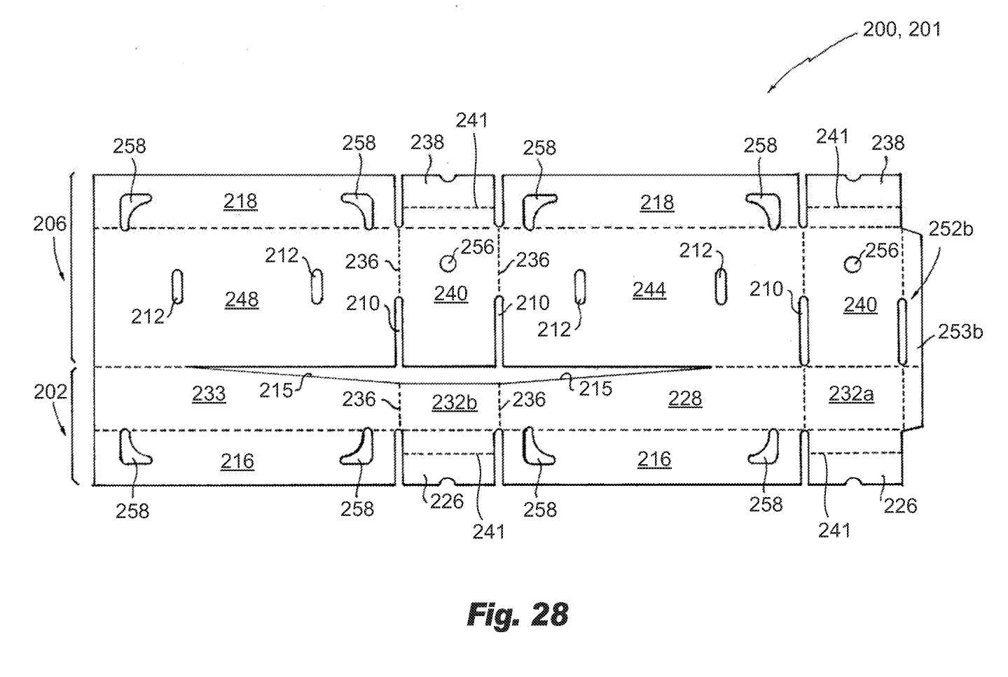

With reference now to FIGS. 25 and 28, alternative embodiments of blank 201 are shown. Blanks 201 of FIGS. 25 and 28 are the same as blanks 201 of FIGS. 22 and 19, respectively, except that blanks 201 of FIGS. 25 and 28 include front and back panels 228 and 233 and side panel 232a that abut break line 224. In this arrangement, upper rim 214 of tray portion 202 is formed when break line 224 is severed/broken from cover portion 206. Because the edge is broken away, as opposed to cut, the upper rim 214 may include nicks or other aspects that may cause roughness along upper rim 214. Cover portion 206 of blank 201 of FIG. 25 is the same as cover portion 206 of blank 201 shown in FIG. 22, and cover portion 206 of blank 201 of FIG. 28 is the same as cover portion 206 of blank 201 shown in FIG. 19. The description provided above for cover portions 206 of FIGS. 19 and 22 readily apply to cover portions 206 of FIGS. 28 and 25, respectively.

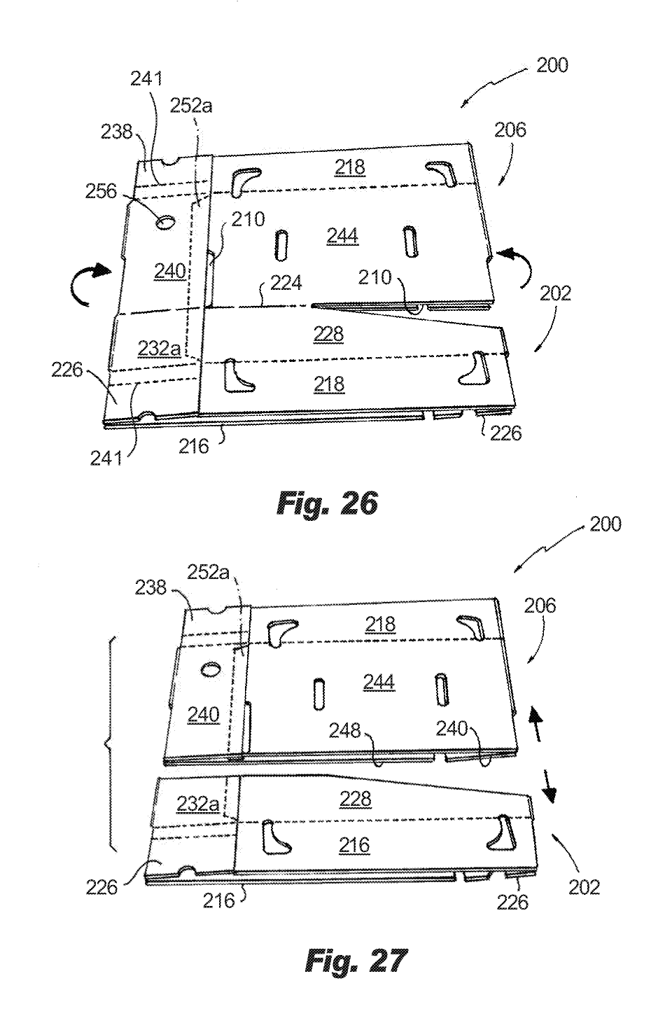

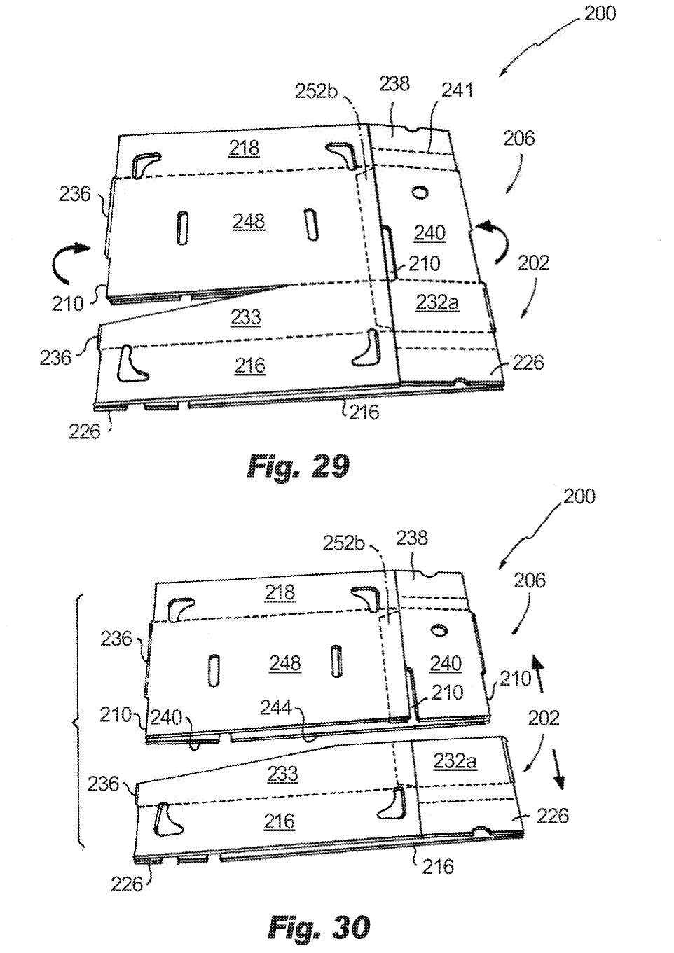

As shown in FIGS. 26-27, to form container 200 using blank 201 FIG. 25, the tray portion 202 is adhered to itself using adhesion tab 252a and the cover portion 206 is adhered to itself in the same manner with the break line 224 initially unbroken. For container 200 formed by blank 201 of FIG. 25, adhesion tab 252a extends from front panels 228 and 244 and an outer surface of adhesion tab 252a (e.g. opposite from inner surface 253a shown in FIG. 25) adheres to inner surfaces of 240 and 232a. As shown in FIGS. 29-30, for container 200 formed by blank 201 of FIG. 28, adhesion tab 252b extends from side panels 240 and 232a and an outer surface of adhesion tab 252b (e.g. opposite from inner surface 253b) adheres to inner surfaces of back panels 248 and 233.

For both FIGS. 25 and 28, because upper rim 214 faces inward when in blank form, adhesion tabs 252a and 252b are not required to extend on to bottom closure flap 226 or bottom panel flap 216. Because adhesion tab 252a does not extend on to its respective bottom closure flap 226, only one ply of material needs to be accounted for when securing bottom closure flap 226 into its respective closure aperture 258. In the flattened states shown in FIGS. 26 and 29, a plurality of containers 200 can be shipped from their place of manufacture to a location where they will be packed. Once line of weakness 224 is broken/severed container 200 can be folded from its flattened state to form a container 200, in the same manner as container 200 shown in 18B.

Those skilled in the art will readily appreciate that, while fold lines and/or lines of weakness may be shown in the figures as being on inner surfaces of a blank, e.g. blanks 101 or 201, various fold lines or lines of weakness can be formed on the outer surface of the blank, or both the outer and inner surfaces of the blank.

A method of forming a container, e.g., containers 100 and/or 200, includes forming a blank as described above, e.g., blank 101 or 201, including forming the break line, e.g. break line 124 or 224, by at least one of knife cutting and/or perforating the blank. The method also includes folding the blank along two of the vertical fold lines, e.g., vertical fold lines 136 or 236, adhering the tray portion, e.g., tray portion 102 or 202, to itself, and adhering the cover portion, e.g., cover portion 106 or 206, to itself. The method also includes breaking the tray portion from the cover portion along the break line, and engaging the bottom closure flaps, e.g., bottom closure flaps 126 or 226, of the tray with the front and back bottom panel flaps, e.g., bottom panel flaps 116 or 216, of the tray portion to form a bottom panel for closure of the tray portion. The method includes engaging the top closure flaps, e.g., top closure flaps 138 or 238, of the cover portion with the front and back top flaps, e.g., top flaps 118 or 218, of the cover portion to form a top panel for closure of the cover portion. The method also includes compressing the cover portion about an opening, e.g., opening 108 or 208, thereof and seating the opening of the cover portion in the tray portion. The container can be converted, e.g. in a retail setting, by removing the cover portion from the tray portion to display product seated in the tray, as shown in FIG. 1 or 18A.

It is also contemplated that optionally, before breaking the break line, the cover portion can be assembled including closing its flaps. The combined container can then be packed with product through the open flaps of the tray portion, which can be closed after the product has filled the combined container. With all of the flaps closed, the break line can be broken to separate the tray portion from the cover portion, and the cover portion can be seated in the tray portion as described above. The container can then be flipped over so the product inside rests on the tray portion.

The methods and systems of the present disclosure, as described above and shown in the drawings, provide for containers with superior properties including manufacture as one piece single-pass cover and tray portion of a container that can be converted for retail display of product within the container. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A container comprising:
a tray portion configured for holding and displaying product; and
a cover portion seated in the tray portion for forming an enclosure around product in the tray portion, wherein the tray portion and the cover portion have the same length and breadth, and wherein at least one of an opening of the cover portion or an opening of the tray portion is slotted with open ended slots to allow at least one of a portion of the opening of the cover portion or a portion of the opening of the tray portion to be biased inward.

2. The container as recited in claim 1, wherein the tray portion has a length dimension and a height dimension, wherein the height dimension of the tray varies along the length dimension of the tray.

3. The container as recited in claim 1, wherein the tray portion defines an opening rim for receiving the opening of the cover portion, wherein the opening rim of the tray portion has a length dimension and a breadth dimension perpendicular to the length dimension, wherein the opening of the cover portion has the same length and breadth dimensions as the opening rim of the tray portion so that the opening of the cover portion must be biased inward, accommodated by the open ended slots, in order for the cover portion to be seated in the tray portion.

4. The container as recited in claim 1, wherein the tray portion has a bottom panel and an opening rim opposite the bottom panel, wherein the open ended slots are defined in the cover portion and, when seated in the tray portion, at least one of the open ended slots extends in a vertical direction from the bottom panel to a height above the opening rim.

5. The container as recited in claim 1, wherein the tray portion includes a pair of side panels opposite from another, wherein a height dimension of one of the side panels is less than a height dimension of the other side panel.

6. The container as recited in claim 1, wherein an adhesion tab extending from a side panel of the tray portion is adhered to a front panel or a back panel of the tray portion, wherein the side panel of the tray has a width dimension that is less than a width dimension of the front panel of the tray and less than a width dimension of the back panel of the tray.

7. A blank for a container comprising:
a tray portion including:
a pair of bottom closure flaps;
a front bottom panel flap and a back bottom panel flap;
a respective side panel connected to each of the bottom closure flaps along a respective fold line;
a front panel connected to the front bottom panel flap along a fold line; and
a back panel connected to the back bottom panel flap along a fold line, wherein the front and back panels are connected to respective ones of the side panels along a plurality of vertical fold lines; and
a cover portion connected to the tray portion across a break line, wherein the cover portion includes:
a pair of top closure flaps;
a front top panel flap and a back top panel flap;
a respective side panel connected to each of the top closure flaps along a respective fold line;
a front panel connected to the front top panel flap along a fold line; and
a back panel connected to the back top panel flap along a fold line, wherein the front and back panels of the cover portion are connected to respective ones of the side panels of the cover portion along a plurality of vertical fold lines.

8. The blank as recited in claim 7, wherein one of the side panels has a first height dimension and another side panel has a second height dimension smaller than the first height dimension.

9. The blank as recited in claim 7, wherein at least one of the front panel or the back panel of the tray portion includes a sloped edge extending between the side panels of the tray portion.

10. The blank as recited in claim 9, wherein the sloped edge of at least one of the front panel or the back panel of the tray portion is opposite from the break line across the at least one of the front panel or the back panel.

11. The blank as recited in claim 7, wherein at least one of the front panel or the back panel of the tray portion includes a respective edge extending between the side panels of the tray portion, wherein the respective edge is opposite from the break line across at least one of the front panel or the back panel.

12. The blank as recited in claim 7, wherein at least one slot is defined through the tray portion and the cover portion across the break line.

13. The blank as recited in claim 7, wherein each of the front top panel flap, the back top panel flap, the front bottom panel flap, and the back bottom panel flap includes at least one closure apertures configured to receive a respective one of the closure flaps.

14. The blank as recited in claim 7, wherein the blank is folded along two of the vertical fold lines, and wherein the tray portion is adhered to itself and the cover portion is adhered to itself with the break line unbroken.

15. The blank as recited in claim 7, wherein an adhesion tab extends from a side panel of at least one of the cover portion or the tray portion, wherein the side panel of at least one of the cover portion or the tray portion has a width dimension that is less than a width dimension of the front or back panel of the cover portion or the tray portion.

16. The blank as recited in claim 7, wherein an adhesion tab extends from a back or front panel of at least one of the tray portion or the cover portion.

17. A method of forming a container comprising:
forming a blank as recited in claim 7, including forming the break line by at least one of knife cutting and/or perforating the blank.

18. The method as recited in claim 17, wherein forming the blank includes forming a sloped edge on at least one of the front or back panels, wherein the sloped edge is formed by knife cutting and is defined between respective vertical fold lines, wherein the method further comprises:
folding the blank along two of the vertical fold lines;
adhering the tray portion to itself; and
adhering the cover portion to itself.

19. The method as recited in claim 18, wherein adhering the tray portion to itself includes adhering an adhesion tab that extends from a side panel of the tray portion to the front panel or the back panel of the tray portion.

20. The method as recited in claim 18, wherein adhering the cover portion to itself includes adhering an adhesion tab that extends from a side panel of the cover portion to the front panel or the back panel of the cover portion.
